(19) United States
(12) Patent Application Publication
(10) Pub. No.: US 2016/0003284 A1
(43) Pub. Date: Jan. 7, 2016

(54) Concrete Screw

(71) Applicant: Hilti Aktiengesellschaft, Schaan (LI)

(72) Inventors: Tobias NEUMAIER, Rankweil (AT); Mark WINKLER, Hohenems (AT); Guenter DOMANI, Weissensberg (DE); Corinna ACHLEITNER, Bludenz (AT)

(73) Assignee: Hilti Aktiengesellschaft, Schaan (LI)

(21) Appl. No.: 14/770,405

(22) PCT Filed: Feb. 12, 2014
(86) PCT No.: PCT/EP2014/052679

§ 371 Date: Aug. 25, 2015

(30) Foreign Application Priority Data
Feb. 26, 2013 (DE) 10 2013 203 151.3

(51) Int. Cl. F16B 25/10; B21H 3/04

(52) U.S. Cl. CPC F16B 25/103; B21H 3/04

(57) ABSTRACT

A concrete screw is disclosed. The concrete screw includes a shank and a thread disposed on the shank with a thread helix and a thread root. A cutting recess is disposed in a tip region of the shank where the cutting recess runs at least in sections within the thread root and without interrupting the thread helix. A rolling die for producing the concrete screw and a method for producing the concrete screw are also disclosed.

This application claims the priority of International Application No. PCT/EP2014/052679, filed Feb. 12, 2014, and German Patent Document No. 10 2013 203 151.3, filed Feb. 26, 2013, the disclosures of which are expressly incorporated by reference herein.

### BACKGROUND AND SUMMARY OF THE INVENTION

The invention relates to a concrete screw. Such a concrete screw is furnished with a shank and a thread arranged on the shank, with a thread helix and a thread root. The invention also relates to a rolling die for producing a concrete screw with a plurality of grooves for rolling a thread. The invention also relates to a production method for a concrete screw according to the invention.

A concrete screw of the type in question is known for example from EP 2 233 757 A2. This specification teaches to provide, in the lateral surface of the shank of the concrete screw, cutting recesses that are bounded by sharp edges. These edges may serve as cutting edges, which can enlarge a non-perfect cylindrical drill hole when screwing in the screw. Therefore, due to the cutting recesses, concrete screws with a relatively large core diameter may be set with relatively low torques, so that relatively high load capacities can be achieved. A production process for a concrete screw with cutting recesses is known from US 2011274516 A. According to US 2011274516 A, first a thread is formed on to the screw shank. Subsequently, by means of diagonally placed milling wheels, notches are milled out of the shank and the thread, which form the cutting recesses.

A rolling die for screws with a drilling tip and scraping groove is known from EP 1 738 844 A1, wherein the scraping groove is rolled in by means of the rolling die in a work step when rolling the thread. To this end, the rolling die of EP 1 738 844 A1 has projections for putting in the scraping groove. The screws with drilling tips known from EP 1 738 844 A1 are not intended for a concrete substrate.

DE 38 23 834 A1 describes a wood screw with engagement locations of drivers, the locations provided on the cylinder core of the thread and produced during the screw manufacturing process, the drivers arranged over the majority of the length of the screw thread and distributed in even intervals on the cylinder core.

The object of the invention is to provide a concrete screw with which, given a particularly low production cost and good settability, particularly good load values can be achieved, as well as a tool and a method for producing such a screw.

A concrete screw according to the invention is characterized in that in the tip region of the shank, there is provided in the shank at least one cutting recess for enlarging a drill hole, which runs at least in sections within the thread root, without interrupting the thread helix.

To start, the invention recognized that for concrete screws, an axial overlapping of the cutting recesses with the thread is frequently associated with advantages. On the one hand, the cutting edges can efficiently cut free the path for the shank in a particularly efficient manner when they are arranged on the tip region of the screw. On the other hand, it may be advantageous in regard to load capacities to construct the thread helix as long as possible and to preferably run it also up to the tip region. This is because when the thread helix extends deep into the drill hole, loads are applied deep in the concrete so that a premature breaking-out of the screw is prevented. However, the invention has now also recognized that the axial overlapping of the cutting recesses with the thread can also be disadvantageous under certain circumstances and with certain applications. This is because when the thread helix in the tip region is interrupted by the cutting recess due to the overlapping, this may involve the undercut surface being decreased and/or the load-bearing thread helix being weakened precisely in the region that is substantially responsible for the deep load application in the concrete and thus for the extraction loads. Building on this knowledge, the invention proposes to extend the cutting recess into the thread, however without the cutting recess interrupting the thread helix. Advantages can hereby be realized that result from an overlapping of the thread and cutting recesses, without disadvantages occurring that could result from an interruption of the thread helix under certain situations. In particular, a concrete screw can thereby be provided with which particularly good extraction loads can be achieved along with good settability. In addition, cutting recesses that do not interrupt the thread can be manufactured in a particularly simple manner in one and the same process step as explained in detail below, so that particularly the manufacturing cost is minimal.

The invention relates to a concrete screw, in other words a screw with a self-tapping thread helix that can be screwed into a concrete structure while forming a counter thread. The cutting recess expediently has at its border at least one cutting edge with which a concrete structure can be cut to enlarge the drill hole. The cutting recess forms a depression in the lateral surface of the shank, which can accommodate concrete dust accumulating during the enlarging, and can thereby ensure a continual cutting action.

The tip of the shank can be understood in particular as the end of the shank, which is first inserted in the drill hole in the structure when the screw is used as intended and/or the end which is opposite a screw head if present. The tip region can be understood as a contiguous region that runs in the proximity of the tip and/or comprises the tip. In particular, the tip region may refer to a region in which the self-tapping thread helix begins. For a concrete screw, the tip often does not run into a pointy end, but has a flat front face, since concrete screws are generally self-tapping, but not self-drilling.

The thread root may refer according to the invention particularly to the region that is surrounded by the thread helix, in other words the region of the thread, which seen in the longitudinal direction of the thread and/or the shank, is bounded on two opposite sides by the thread helix. According to the invention, the thread root, as is typical for a concrete screw, may be significantly wider than the thread helix, seen in the longitudinal direction of the thread and/or the screw, preferably wider by at least a factor of 2, 3, or 4. Additionally or alternatively, the thread root, as is typical for a concrete screw, may be at least almost plane, when seen in the longitudinal section of the screw. The thread root, which may also be described as the thread groove, may be formed in particular by the lateral surface of the shank. The thread root and/or the thread helix is, or are respectively, constructed in a suitably spiral-shaped manner. The shank expediently has at least in sections a cylindrical lateral surface. Preferably, the thread helix according to the invention is completely continuous, in other words not interrupted anywhere.

An advantageous embodiment of the invention lies in the cutting recess being interrupted at least one time by the thread helix of the thread. According to this embodiment, the cutting recess has at least two sub-regions that are separated from each other by the thread helix. The two sub-regions preferably merge with each other; in particular they may lie in a straight line. According to this embodiment, one can execute a cutting recess that is extended particularly in the longitudinal direction of the screw and is thus efficient.

Basically, the cutting recess may run entirely within the thread root without interrupting the thread helix. Particularly preferred, however, is that the cutting recess runs in sections outside of the thread root. Accordingly, the cutting recess extends in sections outside of the thread, in other words also in a region of the shank's lateral surface, which is bounded only on one side by the thread helix, when viewed in the longitudinal direction of the shank. This enables one to bring the cutting recess particularly close to the tip of the screw so that the drill hole can be enlarged in a particularly efficient manner. Among other things, a tapering of the shank in the tip region may hereby become unnecessary without impairing the settability.

In particular, it may be provided that the cutting recess is open toward the front face of the shank. Preferably and according to this embodiment, the cutting recess is visible when looking down on the tip when viewed in the longitudinal direction of the shank. This embodiment may improve the settability even further, on the one hand, because the cutting action hereby occurs already directly at the tip, and on the other, because a removal of concrete dust from the cutting recesses is hereby possible in a particularly simple manner.

Furthermore, it is preferred that the cutting recess runs at least in sections within the first turn of the thread root, beginning at the start of the thread. A cutting action near the tip and thus a particularly good settability can also be achieved hereby. The start of the thread may refer in technical terms to the end of the thread which first cuts into the concrete structure when screwing in the screw. The first turn of the thread root may refer in particular to the first 360° of the circumferential path of the thread root about the longitudinal axis of the shank.

An advantageous embodiment lies in that the depth of the cutting recess amounts to at least 5/100^{th}, preferably at least 10/100^{th} of the shank diameter. Such relatively deep cutting recesses may be particularly good at accommodating the concrete dust that results when the drill hole is enlarged. The depth may be measured particularly in the radial direction of the shank.

Another advantageous embodiment lies in that the cutting recess is asymmetric when the shank is viewed cross-sectionally. In particular, the cutting recess may be asymmetric to the radial direction of the shank. By means of the asymmetric design, the forming resistance when forming the cutting recess may be reduced without substantially affecting the function of the screw in an adverse way.

It is particularly expedient that a cutting recess flank leading in the screw-in direction of the thread helix runs flatter, when the shank is viewed cross-sectionally, relative to the lateral surface of the shank than a cutting recess flank trailing in the screw-in direction. The flank trailing in the screw-in direction is the flank that, in a finished concrete screw, cuts the concrete when being screwed in. At this flank, a steep angle is advantageous for good cutting action. In contrast, the opposite cutting recess flank leading in the screw-in direction of the thread helix generally has a subordinate cutting function at best. This flank is preferably constructed to be flat, since the cutting recess can hereby be furnished with a large surface area so that the cutting recess can accommodate concrete dust in a particularly reliable manner. A flat flank progression may refer in particular to the flank, when the shank is viewed cross-sectionally, enclosing only a small angle with a tangent on the lateral surface of the shank, which originates at the transition of the lateral surface into the flank.

Another advantageous embodiment consists of there being provided in the shank at least an additional cutting recess, which lies in the continuation of the thread helix for free-cutting the thread helix. Such an additional cutting recess, which lies in the continuation, in other words in the imaginary extension of the helix-shaped thread helix, may cut free the region of the thread helix and thereby further simplify the setting of the screw.

In particular, it may be provided that in the tip region of the shank, a plurality of cutting recesses are provided in the shank for enlarging the drill hole, which run at least in sections within the thread root without interrupting the thread helix. By means of the plurality of the similar cutting recesses, a cutting effect distributed across the circumference of the screw, and thus one that is particularly even, can be achieved, which can further support the setting process.

Preferably, at least one additional thread helix can be provided, which runs at least in sections in the thread root, particularly on the thread side opposite the tip region. Such an additional thread helix may be used for example for centering and/or forming additional protection to prevent the screw from coming unscrewed. Fittingly, the additional thread helix has a lower number of turns than the thread helix and/or the height of the additional thread helix is less than or equal to the height as the thread helix. In a multi-start thread, the additional thread helix may also serve to cut into the concrete and have similar dimensions as the thread helix.

It is particularly practical that the screw has a broadened screw head relative to the shank. This screw head may be used for the fixed coupling with a setting tool. For the fixed coupling with a setting tool, the screw head may have for example a polygonal structure, preferably an external hexagonal head.

The invention may be used particularly in connection with concrete screws with relatively thick shanks, in other words for example with those screws in which the ratio of the exterior diameter of the thread to the core diameter of the shank is 1.1 to 1.4. In such screws, the cutting edges formed on the cutting recesses may be particularly effective. The screw consists preferably of a metal material.

A rolling die according to the invention for producing a concrete screw, preferably for producing a concrete screw described in this text, is constructed with a plurality of grooves for rolling a thread. It is characterized in that it has at least one projection for rolling a cutting recess, which does not interrupt the grooves for rolling the thread. With such a rolling die, screws with cutting recesses can be produced in a particularly simple manner, which leave the thread helices of the screw thread intact. As already explained above, particularly good extraction loads can hereby be achieved with good settability. So that the grooves are suited for rolling a thread, they preferably form a thread counter-profile. Preferably, the projection is interrupted by at least one of the grooves.

The rolling die pertains preferably to a flat rolling die, in other words particularly a rolling die with a substantially level work surface, which is moved solely in a linear manner in the rolling process.

Particularly preferred is that the rolling die has at least one projection set consisting of a plurality of projections for multistage rolling of one and the same cutting recess. In other words, a plurality of projections are provided, which sequentially strike and form one and the same cutting recess. These projections form a projection set. According to this embodiment, deep cutting recesses can be rolled with particularly good thread quality. If the screw has a plurality of cutting recesses, a plurality of projection sets may be present that each form one of the cutting recesses in a step-by-step manner. The various projection sets may engage in each other and form an interdigital structure.

For a good rolling result, it is particularly advantageous that the height of the projections of the projection set increase at least in sections in the work direction of the rolling die. Work direction may refer in particular to the direction in which the workpiece moves during rolling on the rolling die.

In a method for producing a concrete screw according to the invention, both the thread helix as well as the cutting recess are formed in the same thread rolling process, preferably by means of a rolling die according to the invention. Accordingly, producing the cutting edge is integrated into the forming production process for the thread so that production is particularly simple and rapid.

It is particularly preferred that the cutting recess is formed by a plurality of projections that are arranged one after another on the one and the same rolling die. According to the embodiment, deep cutting recesses can also be rolled with particularly good thread quality.

In a suitable manner, any existing screw head of the screw is upset prior to the thread rolling process. The screw according to the invention may have, aside from the cutting recess or the cutting recesses, also engagement locations of drivers, which are arranged on the rolling die according to the invention. However, these engagement locations are generally not intended for enlarging a drill hole, particularly because of their geometry.

The invention is explained in greater detail below by means of preferred exemplary embodiments, which are depicted schematically in the attached drawings, wherein individual features of the subsequently depicted exemplary embodiments may be executed in conjunction with the invention individually or in any combination. Schematically depicted in the drawings are:

### BRIEF DESCRIPTION OF THE DRAWINGS

FIG. 1: A side view of an exemplary embodiment of a concrete screw according to the invention;

FIG. 2: The screw from FIG. 1 in a cross-sectional view;

FIG. 3: The screw from FIG. 1 in a perspective view;

FIGS. 4 to 6: A workpiece in various sequential stages during the production sequence of a first embodiment of a method according to the invention for producing a concrete screw;

FIG. 7: The rolling die arrangement according to the invention from FIG. 6 in a perspective view, wherein for clarity's sake the screw head is not depicted; and

FIG. 8: A side view of the rolling die arrangement from FIG. 6, wherein however the screw head is not depicted for clarity's sake.

### DETAILED DESCRIPTION OF THE DRAWINGS

An embodiment of a concrete screw according to the invention is depicted in FIGS. 1 to 3. The screw has a cylindrical shank 31, on whose one end a screw head 39 is constructed, which has a polygonal structure constructed as an external hexagonal head for the form-fitting, rotationally fixed coupling to a setting tool, for example an impact screwdriver. On its opposite end, in other words in the region of the tip, which is first inserted in the drill hole, the shank of the concrete screw has a substantially flat front face 43.

On the lateral surface of the shank 31, there is constructed a thread 33, which has a spiral-shaped thread helix 13 and a spiral-shaped thread root 14 bounded by the thread helix 13. Thread root 14 may refer particularly to the surface region of shank 31, which when viewed in the longitudinal direction of shank 31, is bounded on two axially opposite sides by the thread helix 13.

The start of thread helix 13 lies in the region of the tip of the concrete screw, which means in the tip region 41. In the region of the thread end, in other words on the side of the thread 33 opposite the tip region 41, there is constructed centrally in the thread root 14 an additional thread helix 15. While the thread helix 13 preferably has at least four turns, additional thread helix 15 comprises only about one turn. Thread helix 13 begins preferably directly at the front face 43, however it may also be distanced from it a little bit. The concrete screw may be screwed into a drill hole in a concrete structure in a self-tapping manner in the screw-in direction 81 of the thread 33 marked with an arrow in FIGS. 2 and 3.

In the tip region 41, the concrete screw has a plurality of cutting recesses—six in the depicted embodiment—which are put in the lateral surface of shank 31, wherein in an exemplary manner one of the six cutting recesses is labeled with reference sign 36. The cutting recesses have on their borders at the transition to the cylindrical lateral surface of shank 31 cutting edges that may serve to enlarge a non-perfect cylindrical and/or excessively narrow drill hole when screwing in the screw. The concrete dust accumulating hereby may be at least partially accommodated and/or removed by the cutting recesses. In the depicted exemplary embodiment, the cutting recesses run parallel to each other and parallel to the longitudinal direction of shank 31. In principle, the cutting recesses could also be arranged at an angle to each other and/or to the longitudinal axis.

As shown particularly in FIGS. 1 and 3, the cutting recess 36 is constructed in a two-part manner with two sub-regions 36′ and 36″. The two sub-regions 36′ and 36″ of the cutting recess 36 are aligned with each other, i.e., the first sub-region 36′ lies in the extension of the second sub-region 36″, wherein the two sub-regions 36′, 36″ are separated from each other by the thread helix 13. The first sub-region 36′ lies entirely within the thread root 14, whereas in contrast the second sub-region 36″ lies outside of the thread root 14, in other words in a region that is located so closely to the tip of the screw that it is bounded, when viewed in the longitudinal direction of shank 31, only on one side of the thread helix 13. As shown in FIG. 3 in particular, the cutting recess 36 extends at its second sub-region 36″ to the front face 43 of the shank 31 so that the cutting recess 36 is open toward the front face 43. Thread helix 13 is completely continuous, i.e., none of the cutting recesses interrupt the thread helix 13.

As FIG. 2 shows, cutting recess 36 in the lateral surface of shank 31 may be constructed asymmetrically in the cross-section of the shank 31. In particular, that flank 18, which trails in the screw-in direction 81 defined by the thread helix 13 and labeled in FIGS. 1 and 3 with an arrow, may be constructed more steeply than the opposite leading flank 19. In this way, that flank 18, which acts against the surrounding concrete when screwing in the finished screw, may develop a good cutting action, wherein based on the flat design of the second flank 19, there is a large access surface in the cutting recess 36, which can permit a particularly reliable material transport of concrete dust into the cutting recess 36. The screw-in direction 81, identified in FIGS. 1 and 3 with an arrow, of the thread helix 13 or the thread 33 may in particular be opposite the workpiece rolling-rotation direction 84 when thread rolling, which is identified in FIGS. 6 and 7 with an arrow.

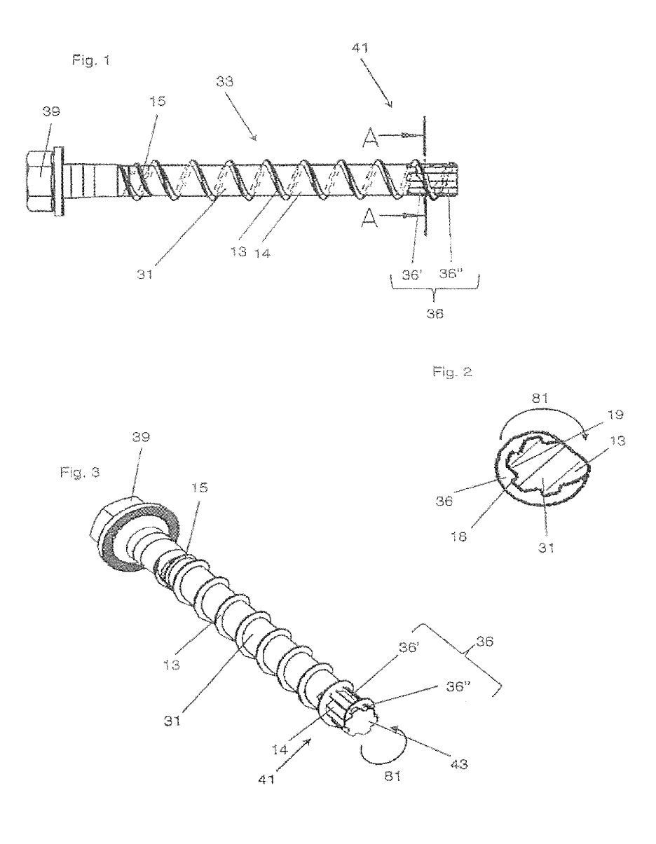

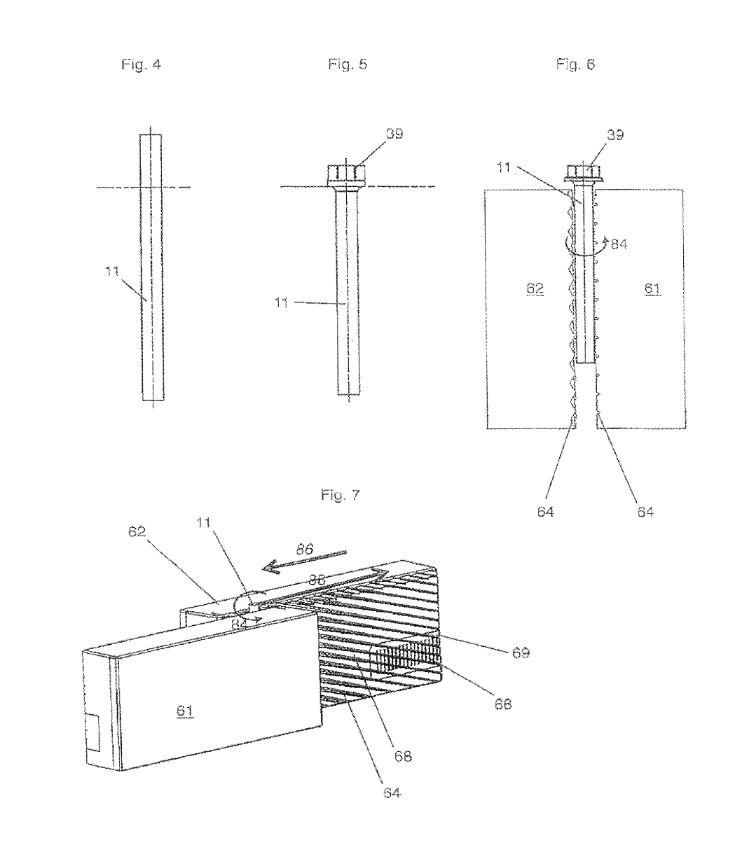

FIGS. 4 to 8 illustrate an embodiment of a method for producing a screw according to the invention, wherein FIGS. 4 to 6 depict a sequence of stages starting with an unprocessed wire piece.

As FIG. 4 shows, the method begins with a straight piece of metal wire being provided as the workpiece 11.

In the following method step, which may comprise a plurality of individual forming steps, the screw head 39 with an external hexagonal structure is made by upsetting on one end of the workpiece 11 thereby the intermediate product shown in FIG. 5 is obtained.

Then, workpiece 11, as shown in FIGS. 6 to 8, is inserted between two rolling dies 61 and 62 according to the invention, which are constructed as flat rolling dies in particular. In the depicted exemplary embodiment, the first rolling die 61 is stationary, whereas the second rolling die 62 is moved linearly in the movement direction 86. Due to the movement of the rolling dies 61 and 62 relative to each other, the workpiece 11 is set into rotation in the workpiece rolling-rotation direction 84 and thereby moved relative to the second rolling die 62 in the work direction 88 of the second rolling die 62. An analogous movement is given relative to the first rolling die 61.

In the rolling process depicted in FIGS. 6 to 8, on the one hand, the thread 33 with the thread helix 13 is rolled on to the lateral surface of the shank 31 and on the other, the cutting recesses 36 are rolled into the lateral surface of the shank 31. The screw in FIGS. 1 to 3 is obtained as an end product.

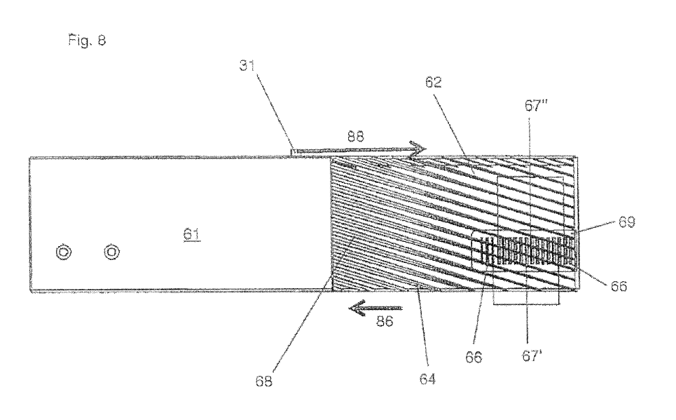

As FIGS. 6 to 8 show, the rolling die 62 according to the invention has on its work surface, running parallel to the drawing plane in FIG. 8, a plurality of grooves 64 running parallel to each other, which serve to form the thread helix 13, and which as such have a counter-form of the thread 33. In addition, the rolling die 62 has a plurality of projections 66, which press the cutting recesses 36 into the shank 31.

The rolling die 62 consists of a main part 68 and an exchangeable plate 69, which is removably connected via screws to the main part 68. The work surface of the rolling die 62 extends both across the main part 68 as well as across the exchangeable plate 69. All projections 66 for the cutting recesses 36, at least however some of them, are preferably arranged on the exchangeable plate 69. The grooves 64 for the thread 33 run both on the main part 68 as well as on the exchangeable plate 69.

The projections 66 for the cutting recesses 36 run, when viewed transversely to the work direction 88, offset to the grooves 64 and do not interrupt the course of the grooves 64. Each of the cutting recesses 36 is not formed by one projection 66 alone, but step-by-step by a plurality of projections 66 arranged one after another in the work direction 88, i.e., for forming a cutting recess 36 a part of the shank 31 is acted upon by a plurality of projections 66 one after another. The entirety of all projections 66, which form one of the cutting recesses 36, form a projection set, wherein in an exemplary manner in FIG. 8, two different projection sets 67′ and 67″ are labeled for two different cutting recesses 36. It is particularly preferred that the height of the projections 66 of a projection set 67 increases at least in sections along the work direction 88, so that the corresponding cutting recess is formed successively deeper.

The first rolling die 61 is constructed analogously to the second rolling die 62 with grooves and projections, if applicable also with projection sets, a main part and/or exchangeable plate.

1.-15. (canceled)

16. A concrete screw, comprising:
a shank; and
a thread disposed on the shank with a thread helix and a thread root;
wherein a cutting recess is disposed in a tip region of the shank and wherein the cutting recess runs at least in sections within the thread root and without interrupting the thread helix.

17. The concrete screw according to claim 16, wherein the cutting recess is interrupted at least one time by the thread helix.

18. The concrete screw according to claim 16, wherein the cutting recess runs in at least one section outside of the thread root and wherein the cutting recess is open toward a front face of the shank.

19. The concrete screw according to claim 16, wherein the cutting recess runs at least in a section within a first turn of the thread root beginning at a thread start.

20. The concrete screw according to claim 16, wherein a depth of the cutting recess is at least 10/100th of a diameter of the shank.

21. The concrete screw according to claim 16, wherein the cutting recess, in a cross-sectional view of the shank, is asymmetric wherein a first flank of the cutting recess leading in a screw-in direction of the thread helix runs flatter relative to a lateral surface of the shank than a second flank of the cutting recess trailing in the screw-in direction.

22. The concrete screw according to claim 16, further comprising a second cutting recess in the shank.

23. The concrete screw according to claim 16, wherein in the tip region of the shank, a plurality of cutting recesses are disposed which run at least in sections inside the thread root without interrupting the thread helix.

24. The concrete screw according to claim 16, further comprising a second thread helix which runs at least in a section in the thread root on a side of the thread opposite the tip region.

25. The concrete screw according to claim 16, further comprising a screw head that is broadened relative to the shank.

26. A rolling die for producing a concrete screw, comprising:
a plurality of grooves for rolling a thread; and
at least one projection for rolling a cutting recess which does not interrupt the plurality of grooves for rolling the thread.

27. The rolling die according to claim 26, further comprising at least one projection set including a plurality of projections for a multi-stage rolling of a cutting recess.

28. The rolling die according to claim 27, wherein a height of the plurality of projections increases at least in sections in a work direction of the rolling die.

29. A method for producing a concrete screw according to claim 16 in which both the thread helix and the cutting recess are formed in a same thread rolling process by a rolling die according to claim 26.

30. The method according to claim 29, wherein the cutting recess is formed by a plurality of projections which are disposed one after another on the rolling die.
